(19) United States
(12) Patent Application Publication
(10) Pub. No.: US 2025/0158009 A1
(43) Pub. Date: May 15, 2025

(54) ELECTRODE PRODUCTION APPARATUS, STACK SEPARATOR PRODUCTION APPARATUS, LIQUID APPLICATION APPARATUS, ELECTRODE PRODUCTION METHOD, STACK SEPARATOR PRODUCTION METHOD, AND LIQUID APPLICATION METHOD

(71) Applicant: Yuuji OHMURA, Kanagawa (JP)

(72) Inventor: Yuuji OHMURA, Kanagawa (JP)

(21) Appl. No.: 18/836,015

(22) PCT Filed: Feb. 3, 2023
(86) PCT No.: PCT/IB2023/050940

§ 371 Date: Aug. 6, 2024

(30) Foreign Application Priority Data
Feb. 21, 2022 (JP) 2022-024421

(51) Int. Cl. H01M 4/04

(52) U.S. Cl. CPC H01M 4/0404

(57) ABSTRACT

An electrode production apparatus is provided including an application part and a suction conveying part. The application part is configured to apply a liquid composition to an electrode element being conveyed in a conveying direction, to form a function layer. The suction conveying part is configured to convey the electrode element while sucking the electrode element in a direction opposite to the application part. The electrode element is a thin film.

### TECHNICAL FIELD

The present disclosure relates to an electrode production apparatus, a stack separator production apparatus, a liquid application apparatus, an electrode production method, a stack separator production method, and a liquid application method.

### BACKGROUND ART

Patent Literature 1 describes a production method of a lithium ion secondary cell that includes at least a positive plate including a positive-electrode active material layer containing lithium composite oxide particles, a negative plate including a negative-electrode active material layer containing negative-electrode active material particles, and a porous insulating layer disposed on the surface of at least either the positive-electrode active material layer or the negative-electrode active material layer, and a separator interposed between the positive- and negative-electrode plates, and that has a step of mixing at least an inorganic oxide filler, a resin binder, and a solvent and forming a slurry, and a step of pattern-coating the slurry onto the surface of at least either the positive-electrode active material layer or the negative-electrode active material layer by inkjet printing.

Patent Literature 2 describes roll-pressing equipment for an electrode material that provides roll-pressing equipment including a wrinkle generation preventing mechanism for an electrode material that can deal with formation of thin foil from a belt-shaped electrode material substrate, and in turn, speeding-up of roll-pressing speed of an electrode material.

### CITATION LIST

### Patent Literature

### [PTL 1]

Japanese Unexamined Patent Application Publication No. 2005-174792

### [PTL 2]

Japanese Unexamined Patent Application Publication No. 2012-129147

### SUMMARY OF INVENTION

### Technical Problem

The present embodiment has an object to reduce a shift of a position of a liquid composition applied to a thin film.

### Solution to Problem

Embodiments of the present invention provides an electrode production apparatus including an application part and a suction conveying part. The application part is configured to apply a liquid composition to an electrode element being conveyed in a conveying direction, to form a function layer. The suction conveying part is configured to convey the electrode element while sucking the electrode element in a direction opposite to the application part. The electrode element is a thin film.

### Advantageous Effects of Invention

According to embodiments of the present invention, a shift of a position of a liquid composition applied to a thin film can be reduced.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a general configuration diagram of an electrode production apparatus according to an embodiment of the present invention.

FIG. 2 is a perspective view of a suction conveying part according to an embodiment of the present invention.

FIG. 3 is an explanatory diagram of control of a printing part according to an embodiment of the present invention.

FIGS. 4A and 4B are cross-sectional views of electrode elements according to embodiments of the present invention.

FIGS. 5A to 5F are explanatory diagrams of a web W according to Example 2 depicted in FIG. 4B

FIGS. 6A to 6D are explanatory diagrams of comparative examples.

FIGS. 7A and 7B are explanatory diagrams of conveyance of a web W according to embodiments of the present invention.

FIGS. 8A and 8B are explanatory diagrams of a second comparative example.

FIG. 9 is an explanatory diagram of the second comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

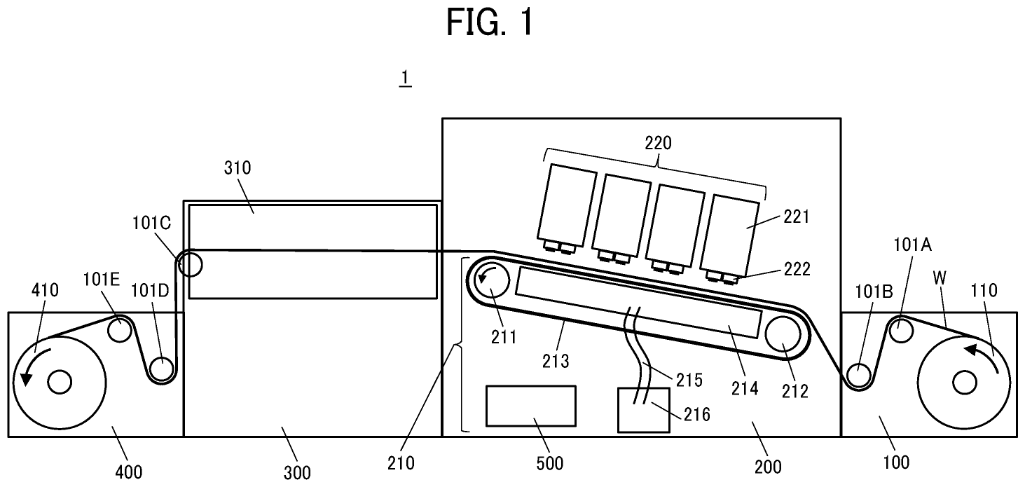

FIG. 1 is a general configuration diagram of an electrode production apparatus according to an embodiment of the present invention. An electrode production apparatus 1 is an apparatus that applies a liquid composition onto the surface of a thin-film electrode element to form a function layer and thereby produces an electrode included in an electrochemical element such as a primary cell, a secondary cell, or a capacitor; is one example of a liquid application apparatus; and is also one example of an electrode production apparatus included in an electrochemical element production apparatus. In addition, detail of the electrode element, the thin film, and the function layer will be described later.

The electrode production apparatus 1 includes a reel-out part 100, a printing part 200, a drying part 300, and a reel-in part 400.

The reel-out part 100 includes a reel-out roll 110 configured to rotate with having a winding of a web W, which is an example of the thin film, and guide rollers 101A and 101B that convey the web W reeled out from the reel-out roll 110 to the printing part 200.

The printing part 200 includes a suction conveying part 210 that sucks and conveys the web W sent from the reel-out part 100, and an inkjet part 220 that discharges ink, which is an example of the liquid composition, onto the surface of the web W being conveyed from the suction conveying part 210.

The drying part 300 includes a drying oven 310 that dries the ink on the surface of the web W sent from the printing part 200, and a guide roller 101C that conveys the web W sent from the drying oven 310. The drying oven 310 has functions to heat the ink on the surface of the web W and dry a solvent remaining in the ink, to promote curing of the ink, and to otherwise provide a process.

The reel-in part 400 includes guide rollers 101D and 101E that convey the web W sent from the drying part 300, and a reel-in roll 410 that reels the web W sent from the guide roller 101E.

The inkjet part 220 is an example of the application part, and includes, along a conveying direction of the web W, a plurality of inkjet Mds 221 each including a plurality of inkjet heads 222 to discharge ink onto the surface of the web W.

The suction conveying part 210 includes a blower 216 that sucks air, a suction chamber 214 that communicates with the blower 216 via a duct 215, a belt 213 that conveys the web W being sucked in a direction opposite to the inkjet part 220, a belt driving roller 211 that winds the belt 213 to drive, and a belt following roller 212 that extends the belt 213 to rotate accordingly.

Since the belt 213 is conveyed in circulation by rotation of the belt driving roller 211, the web W sucked by the belt 213 is conveyed at approximately the same speed as a rotation speed of the belt 213.

The electrode production apparatus 1 may also include a curing part that cures an ink layer on the surface of the web W into a resin layer by ultraviolet rays, between the printing part 200 and the drying part 300, depending on in the composition of the ink discharged from the inkjet head 222. Such an ink may contain a polymerizable compound, such as a monomer, as a constituent.

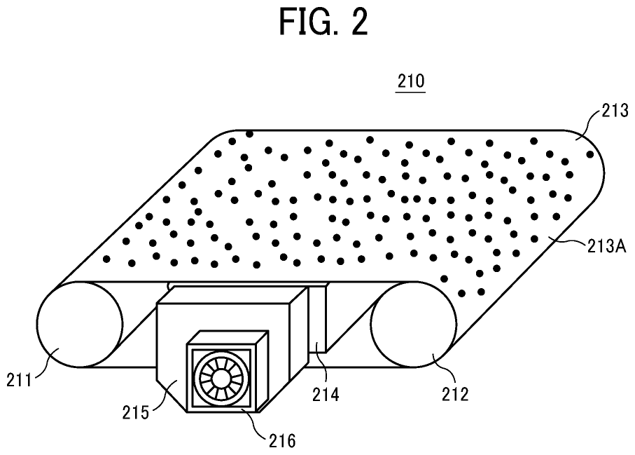

FIG. 2 is a perspective view of a suction conveying part according to the present embodiment.

The belt 213 has a large number of minute suction pores 213A throughout the whole circumference. When the blower 216 sucks air and generates negative pressure in the suction chamber 214, the air sucked from the suction pores 213A generates suction force on the surface of the belt 213, thereby drawing the web W onto the surface of the belt 213.

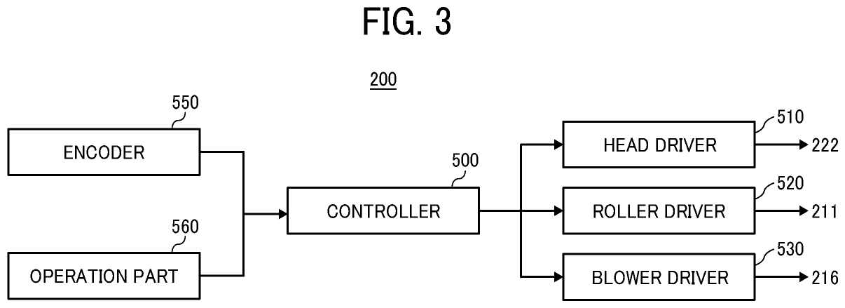

FIG. 3 is an explanatory diagram of a controller according to the present embodiment.

The printing part 200 includes a controller 500, a head driver 510 that drives the inkjet head 222, a roller driver 520 that drives the belt driving roller 211, a blower driver 530 that drives the blower 216, an encoder 550 that detects a rotation speed of the belt following roller 212, and an operation part 560 that accepts an operational input by a user.

The controller 500 controls the roller driver 520 to control a rotation speed of the belt driving roller 211, based on a rotation speed of the belt following roller 212 detected by the encoder 550, i.e., a conveyance speed for conveyance of the web W, and also controls the head driver 510 to control a timing for discharging ink from the inkjet head 222.

The controller 500 also controls the blower driver 530 to control a suction amount of the blower 216, based on input information indicating the type of the web W input by the operation part 560.

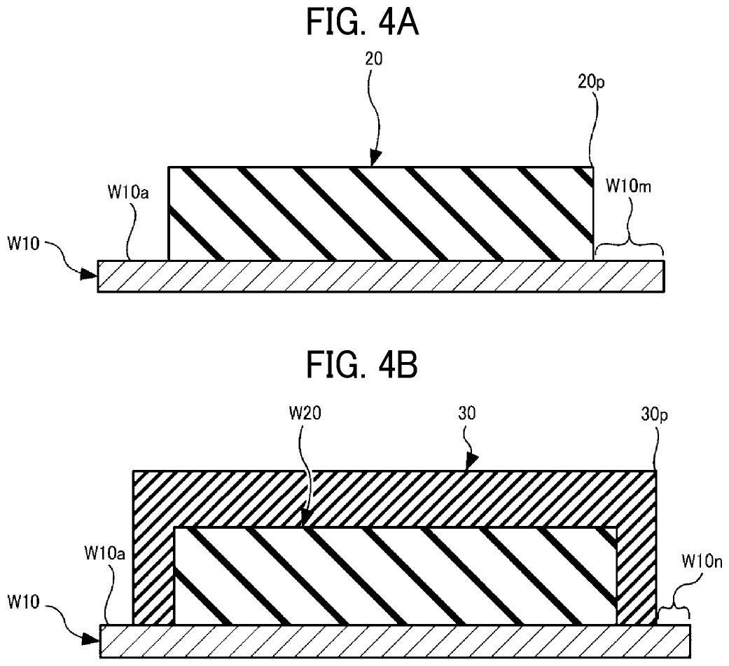

FIGS. 4 and 4B are cross-sectional views of an electrode according to the present embodiment.

The electrode element is an element that has an electric charging and discharging function, an insulating function, and the like in an electrochemical element. In this case, the electrode element may be formed of a single function layer, or may have a plurality of function layers. Examples of the function layers include an electrically conductive layer formed of a current collector or the like, a capacitance generation layer formed of an active material or the like, an inorganic particle membrane or a resin membrane, and an insulating layer formed of a solid electrolyte or the like.

FIG. 4A is a cross-sectional view of an electrode according to Example 1, and depicts an electrode where an active material layer 20 is formed as a function layer on the surface of an electrode substrate W10 as an electrode element conveyed as the web W. The active material layer 20 is an example of an electrode composite layer.

In one face W10a of the electrode substrate W10, the electrode substrate W10 is coated with the active material layer 20 except for an exposed part W10m. The exposed part W10m is disposed along the outside of an outer circumferential part 20p of the active material layer 20, and may be disposed circularly, in a planar view as seen in a normal direction of the one face W10a. The shape of the electrode substrate W10 and the active material layer 20 is exemplarily depicted, and is not limited to the shape in FIG. 4A.

The thickness of the electrode substrate W10 is e.g., about 5 μm to 20 μm, and the thickness of the active material layer 20 is e.g., about several tens μm to 100 μm.

The electrode substrate W10 has no particular limitation if being a substrate having electrical conductivity, and employs aluminum foil, copper foil, stainless foil, titanium foil, and etched foil derived by etching the precedent foil to make a minute hole, which can be generally and preferably used for a storage device such as a secondary cell or a capacitor, in particular, a lithium ion secondary cell; a perforated electrode substrate used for a lithium ion capacitor; or the like.

Further, carbon paper used for power generation elements (e.g., fuel cells), a fibrous electrode which is in a non-woven or woven planar form, and the above-described perforated electrode substrate which has fine holes may also be used.

Moreover, for solar devices, a flat substrate made of glass or plastic may also be used on which a transparent semiconductor film of indium-titanium oxide or zinc oxide is formed or a thin conductive electrode film is deposited, in addition to the above-described electrode.

As an active material, a positive-electrode active material or a negative-electrode active material applicable to an electrochemical element can be used.

The positive-electrode active material has no particular limitation if reversibly occluding and discharging an alkali metal ion, and can employ an alkali metal-containing transition metal compound.

Examples of the alkali-metal-containing transition metal compounds include, but are not limited to, lithium-containing transition metal compounds such as a composite oxide comprising lithium and one or more elements selected from the group consisting of cobalt, manganese, nickel, chromium, iron, and vanadium.

Examples of the lithium-containing transition metal compounds include, but are not limited to, lithium cobalt oxide, lithium nickel oxide, and lithium manganese oxide.

As the alkali metal-containing transition metal compound, a polyanion-based compound having an XO4 tetrahedron (X═P, S, As, Mo, W, Si, etc.) in a crystal structure can also be used. Among them, a lithium-containing transition metal phosphate compound such as lithium iron phosphate or lithium vanadium phosphate is preferable in view of cycle characteristics, and lithium vanadium phosphate is particularly preferable in view of lithium diffusion coefficient, and input/output characteristics of an electrochemical element.

Preferably, the polyanionic compounds are surface-coated with a conductive auxiliary agent such as a carbon material for electron conductivity.

The negative-electrode active material has no particular limitation if reversibly occluding and discharging an alkali metal ion, and can employ a carbon material containing graphite having a graphite-type crystal structure.

Examples of the carbon materials include, but are not limited to, natural graphite, synthetic graphite, poorly-graphitizable carbon (hard carbon), and easily-graphitizable carbon (soft carbon).

Examples of the negative electrode active material other than the carbon materials include, but are not limited to, lithium titanate and titanium oxide.

Additionally, in view of energy density of an electrochemical element, a high-capacitance material such as silicon, tin, silicon alloy, tin alloy, silicon oxide, silicon nitride, or tin oxide is preferably used as the negative-electrode active material.

A dispersion medium has no particular limitation if dispersible of an active material, and examples thereof include ethyleneglycol, propyleneglycol, N-methyl-2-pyrrolidone, cyclohexanone, acetic acid ester, mesitylene, 2-n-butoxymethanol, 2-dimethylethanol, N,N-dimethylacetoamide, N,N-dimethylformamide, dimethylsulfoxide, lactic acid ester, tetramethylurea, anisole, dibutylether, and 1,2-diethoxyethane, two or more kinds of which may be used in combination.

FIG. 4B is a cross-sectional view of an electrode according to Example 2, and depicts an electrode where an insulating layer 30 is formed as a function layer by discharging ink onto the surface of an active material layer W20 in a stack of the electrode substrate W10 and the active material layer W20 as an electrode element conveyed as the web W. The active material layer W20 is an example of an electrode composite layer.

In the one face W10a of the electrode substrate W10, the active material layer W20 is entirely coated with the insulating layer 30 without being exposed, and the electrode substrate W10 is coated with the insulating layer 30 except for an exposed part W10n. The exposed part W10n is disposed along the outside of an outer circumferential part 30p of the insulating layer 30, and may be disposed circularly, in a planar view as seen in a normal direction of the one face W10a. The shape of the electrode substrate W10, the active material layer 20, and the insulating layer 30 is exemplarily depicted, and is not limited to the shape in FIG. 4B.

In addition, the web W as an electrode element including the electrode substrate W10 and the active material layer W20 may be conveyed after being pressed for increasing a density of the active material layer W20.

The thickness of the electrode substrate W10 is e.g., about 5 μm to 20 μm, the thickness of the active material layer W20 is e.g., about several tens μm to 100 μm, and the thickness of the insulating layer 30 is e.g., about 0.5 μm to 20 μm, and preferably about 1 to 7 μm.

The electrode substrate W10 has no particular limitation if being a substrate having electrical conductivity, and employs aluminum foil, copper foil, stainless foil, titanium foil, and etched foil derived by etching the precedent foil to make a minute hole, which can be generally and preferably used for a storage device such as a secondary cell or a capacitor, in particular, a lithium ion secondary cell; a perforated electrode substrate used for a lithium ion capacitor; or the like.

Further, carbon paper used for power generation elements (e.g., fuel cells), a fibrous electrode which is in a non-woven or woven planar form, and the above-described perforated electrode substrate which has fine holes may also be used.

Moreover, for solar devices, a flat substrate made of glass or plastic may also be used on which a transparent semiconductor film of indium-titanium oxide or zinc oxide is formed or a thin conductive electrode film is deposited, in addition to the above-described electrode.

Meanwhile, the active material layer W20 contains an active material. As an active material, a positive-electrode active material or a negative-electrode active material applicable to an electrochemical element can be used.

The positive-electrode active material has no particular limitation if reversibly occluding and discharging an alkali metal ion, and can employ an alkali metal-containing transition metal compound.

Examples of the alkali-metal-containing transition metal compounds include, but are not limited to, lithium-containing transition metal compounds such as a composite oxide comprising lithium and one or more elements selected from the group consisting of cobalt, manganese, nickel, chromium, iron, and vanadium.

Examples of the lithium-containing transition metal compounds include, but are not limited to, lithium cobalt oxide, lithium nickel oxide, and lithium manganese oxide.

As the alkali metal-containing transition metal compound, a polyanion-based compound having an XO4 tetrahedron (X═P, S, As, Mo, W, Si, etc.) in a crystal structure can also be used. Among them, a lithium-containing transition metal phosphate compound such as lithium iron phosphate or lithium vanadium phosphate is preferable in view of cycle characteristics, and lithium vanadium phosphate is particularly preferable in view of lithium diffusion coefficient, and input/output characteristics of an electrochemical element.

Preferably, the polyanionic compounds are surface-coated with a conductive auxiliary agent such as a carbon material for electron conductivity.

The negative-electrode active material has no particular limitation if reversibly occluding and discharging an alkali metal ion, and can employ a carbon material containing graphite having a graphite-type crystal structure.

Examples of the carbon materials include, but are not limited to, natural graphite, synthetic graphite, poorly-graphitizable carbon (hard carbon), and easily-graphitizable carbon (soft carbon).

Examples of the negative electrode active material other than the carbon materials include, but are not limited to, lithium titanate and titanium oxide.

Additionally, in view of energy density of an electrochemical element, a high-capacitance material such as silicon, tin, silicon alloy, tin alloy, silicon oxide, silicon nitride, or tin oxide is preferably used as the negative-electrode active material.

A dispersion medium has no particular limitation if dispersible of an active material, and examples thereof include ethyleneglycol, propyleneglycol, N-methyl-2-pyrrolidone, cyclohexanone, acetic acid ester, mesitylene, 2-n-butoxymethanol, 2-dimethylethanol, N,N-dimethylacetoamide, N,N-dimethylformamide, dimethylsulfoxide, lactic acid ester, tetramethylurea, anisole, dibutylether, and 1,2-diethoxyethane, two or more kinds of which may be used in combination.

The constituent of ink for forming the insulating layer 30 includes inorganic particles and a dispersion medium when forming an inorganic layer as an insulating layer, and includes a polymerizable compound and a solvent when forming a resin layer as an insulating layer.

### Liquid Composition for Inorganic Layer Formation

The inorganic particles are preferably insulating inorganic particles, and examples thereof include particles containing metal oxide, metal nitride, or other metal compounds as a material.

Examples of metal oxide include Al₂O₃, TiO₂, BaTiO₃, and ZrO₂.

Examples of the metal nitrides include, but are not limited to, aluminum nitride and silicon nitride. Examples of other metal compounds include poorly-soluble ion crystals of aluminum fluoride, calcium fluoride, barium fluoride, barium sulfate, and the like; and substances derived from mineral resources such as boehmite, zeolite, apatite, kaolin, mullite, spinel, olivine, sericite, and bentonite, and artificial substances thereof.

Examples of a material formed of the insulating inorganic particles other than the materials described above include glass ceramic.

Examples of glass ceramic include crystalized glass ceramic using ZnO-MgO-Al₂O₃-SiO₂-based crystalized glass, and non-glass based ceramic using BaO-Al2O3-SiO2-based ceramic, Al₂O₃-CaO-SiO₂-MgO-B₂O₃-based ceramic, or the like.

The insulating inorganic particles preferably contain an ion-conductive element. Examples of the ion-conductive element include silicon element, aluminum element, and zirconium element. These ion-conductive elements may be used singly or in combination of two or more kinds.

The insulating inorganic particles are preferably Al₂O₃ (alumina) particles. As the insulating inorganic particles, α-alumina, which has high melting point and heat stability, is preferably used among alumina.

The dispersion medium means water or a non-aqueous dispersion medium. Examples of a non-aqueous dispersion medium include styrene, toluene, xylene, methylethylketone, ethyl acetate, acetone, methanol, ethanol, n-propanol, isopropanol (IPA), n-butanol, isobutanol, ter-butanol, n-pentanol, n-hexanol, diacetone alcohol, N,N-dimethylformamide (DMF), N,N-dimethylsulfoxide (DMSO), N-methylpyrrolidone (NMP), and tetrahydrofuran (THF).

The dispersion mediums can be used singly or can be used in combination of a plurality of dispersion mediums.

### Liquid Composition for Resin Layer Formation

The polymerizable compound forms a resin by polymerization, and forms a porous resin when polymerized in a liquid composition.

A resin formed of the polymerizable compound is preferably a resin having a reticulate structure formed by application of activation energy rays or the like (e.g., emission of light and application of heat), and preferable examples include acrylate resins, methacrylate resins, urethaneacrylate resins, vinyl ester resins, unsaturated polyester resins, epoxy resins, oxetan resins, vinyl ether resins, and resins formed by a thiol-ene reaction.

Additionally, more preferable are resins formed of a polymerizable compound having a (meth)acryloyl group, such as acrylate resins, methacrylate resins, and urethaneacrylate resins, in view of ease of formation of a structure using a highly-reactive radical polymerization; or resins formed by a polymerizable compound having a vinyl group, such as vinyl ester resins, in view of productivity.

These may be used singly or in combination of two or more kinds. In combination use of two or more kinds, a combination of the polymerizable compounds has no limitation, and can be appropriately selected according to a purpose, and for example, an urethaneacrylate resin is preferably mixed as a main constituent with another resin for the purpose of applying flexibility. Herein a polymerizable compound having an acryloyl group or a methacryloyl group is referred to as a polymerizable compound having a (meth) acryloyl group.

The active energy rays are not particularly limited as long as they can impart energy necessary for proceeding a polymerization reaction of the polymerizable compound in the liquid composition. Examples thereof include, but are not limited to, ultraviolet rays, electron beams, α-rays, β-rays, γ-rays, and X-rays. Among these, ultraviolet rays are preferred. Particularly when a high-energy light source is used, the polymerization reaction can proceed without using any polymerization initiator.

The solvent (hereinafter also referred to as “porogen”) is a liquid compatible with the polymerizable compound. The solvent is a liquid that becomes incompatible (causes phase separation) with the resulting polymer (resin) in the process of polymerizing the polymerizable compound in the liquid composition. Presence of the solvent in a liquid composition allows the polymerizable compound to form a porous resin when polymerizing in a liquid composition.

It is preferable that the solvent X be capable of dissolving a compound (i.e., polymerization initiator to be described later) that generates radicals or acids by light or heat. The solvent may be used singly or in combination of two or more kinds. Note that in the embodiment, the solvent is not polymerizable.

The melting point of a single kind or a combination of two or more kinds of porogens is preferably 50° C. or higher and 250° C. or lower, and more preferably 70° C. or higher and 200° C. or lower in normal pressure.

When the boiling point is 50 degrees C. or higher, vaporization of the porogen at around room temperature is suppressed, handling of the liquid composition becomes easy, and the amount of porogen in the liquid composition can be easily controlled.

Meanwhile, a melting point of 250° C. or lower leads to reduction in duration of a step of drying a porogen after polymerization, thereby improving productivity of a porous resin.

It is also possible to reduce an amount of a porogen(s) remaining within a porous resin, thus improving quality in use of the porous resin as a function layer, such as a substance separation layer that separates substances or a reaction layer that serves as a reaction field.

In addition, the melting point of a porogen(s) in use as a single kind or in combination of two or more kinds is preferably 120° C. or higher in normal pressure.

Specific examples of the porogen include, but are not limited to: ethylene glycols such as diethylene glycol monomethyl ether, ethylene glycol monobutyl ether, ethylene glycol monoisopropyl ether, and dipropylene glycol monomethyl ether; esters such as γ-butyrolactone and propylene carbonate; and amides such as N,N-dimethylacetamide. Specific examples thereof further include liquids having a relatively large molecular weight, such as methyl tetradecanoate, methyl decanoate, methyl myristate, and tetradecane.

Specific examples thereof further include liquids such as acetone, 2-ethylhexanol, and 1-bromonaphthalene.

Note that in the embodiment, the liquids exemplified above do not always fall under a category of porogens.

A porogen in the embodiment is, as described above, a liquid compatible with the polymerizable compound, and also a liquid that becomes incompatible (causes phase separation) with the resulting polymer (resin) in the process of polymerizing the polymerizable compound in a liquid composition.

In other words, whether or not a liquid serves as a porogen depends on the relation between the polymerizable compound and the resulting polymer (the resin formed by polymerization of the polymerizable compound).

Furthermore, a liquid composition in the embodiment preferably contains at least a single kind of porogen having the aforementioned certain relation with the polymerizable compound, thus providing a broader range of options of materials in preparation of a liquid composition and making design of a liquid composition easier.

The broader range of options of materials in preparation of a liquid composition provides a broader range of options of measures when a liquid composition has a characteristic preferred in a view other than formation of a porous structure.

For example, in discharge of a liquid composition in an inkjet mode, the liquid composition preferably has discharge stability and the like in a view other than porous formation; nevertheless, a broad range of options of materials provides ease of design of the liquid composition.

In addition, a liquid composition in the embodiment, as described above, preferably contains at least a single kind of porogen having the aforementioned certain relation with the polymerizable compound, and thus may also additionally contain a liquid not having the aforementioned certain relation with the polymerizable compound (non-porogen liquid).

Recently, electrodes have had a thinner film in order to provide an electrochemical element with lower cost and higher capacitance, and both Example 1 depicted in FIG. 4A and Example 2 depicted in FIG. 4B are more likely to generate a wrinkle in a thin-film electrode clement such as a current collector or a separator.

Herein a thin film in the embodiment has no limitation in a material, a thickness, or the like, and refers to a membrane with a thinness that may cause generation of a wrinkle during conveyance. In particular, the film refers to a membrane with a thinness such that in conveyance with applying tension, a position of a wrinkle is changed during conveyance because of local tension distributed ununiformly.

In particular, the thin film is not limited to a “membrane”, may be a so-called “film” used as a separator, or a so-called ‘foil” used as a current collector, and may be a stack including a plurality of stacked layers if having a thinness such that a wrinkle can be generated during conveyance.

Note that typical paper used for a printer or the like has a large basis weight, and would not have change in a position of a wrinkle during conveyance due to local tension distributed ununiformly when conveyed with application of tension, and thus does not fall under a category of the thin films in the embodiment.

While various measures for a wrinkle of an electrode element have been thus made, the Applicant found a problem in that in discharge of ink onto the surface of a thin film by inkjet to form a layer, a wrinkle of a thin film being conveyed causes a shift of a position of ink applied onto a thin film, thereby preventing formation of a desired layer.

In other words, given that a wrinkle of a thin film represents a state of a thin film having a cavity and projection, it is found that when ink discharged by inkjet lands onto a cavity part of a thin film being conveyed, ink do not land at an intended landing position located in an upstream part relative to the cavity part in a conveying direction.

There have been particular concerns that in landing of ink for formation of an electrode composite layer as a function layer onto a current collector having a shape of a thin film, failure in landing of the ink onto an intended landing position may cause ununiform formation of an electrode composite layer, thus affecting charging and discharging characteristics in use for an electrochemical element; and further that, in formation of an insulating layer as a function layer on the electrode composite layer, difference in the thickness of the electrode composite layer may generate an unintended exposed area of the electrode composite layer uncoated with the insulating layer, thus affecting quality.

There has been another concern that in landing of ink for formation of an insulating layer as a function layer on an electrode element having a shape of a thin film that has a configuration including a stack of an electrode composite layer on a current collector, failure in landing of the ink onto an intended landing position may cause generation of an unintended exposed area of an electrode composite layer uncoated with an insulating layer, thus affecting quality.

In view of the aforementioned problems, the embodiment has an object to reduce a shift of a position of a liquid composition applied onto a thin film due to a wrinkle of the thin film being conveyed. Particularly in production of an electrode, the embodiment has an object to reduce a shift of a position of a liquid composition applied onto a thin film due to a wrinkle of an electrode element having a shape of a thin film being conveyed, and thereby provide a production method of an electrode and an electrochemical element having good charging and discharging characteristics and quality.

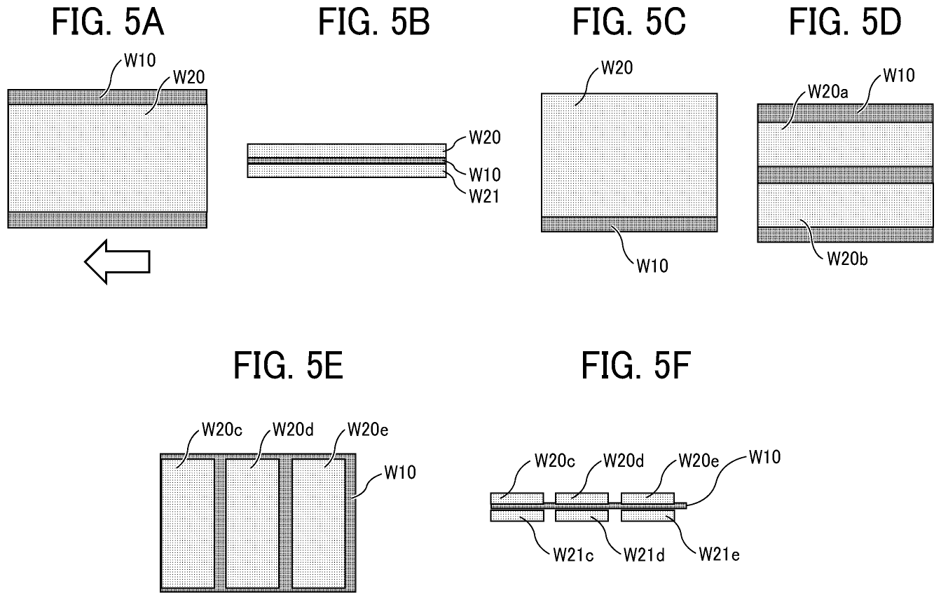

FIGS. 5A to 5F are explanatory diagrams of the web W according to Example 2 depicted in FIG. 4B.

FIG. 5A is a top view of the web W according to Example 2, and an arrow indicates a conveying direction of the web W.

In a direction perpendicular to the conveying direction, the central part of the electrode substrate W10 has a stack of the active material layer W20, and both end parts of the electrode substrate W10 has no stack of the active material layer W20.

FIG. 5B is a cross-sectional view of the web W according to Example 2, in which not only the front side of the electrode substrate W10 has a stack of the active material layer W20, but also the back side of the electrode substrate W10 has a stack of an active material layer W21.

FIG. 5C is a top view of another example of the web W according to Example 2. In a direction perpendicular to the conveying direction, the central part to one end side of the electrode substrate W10 has a stack of the active material layer W20, and the other end part of the electrode substrate W10 has no stack of the active material layer W20.

FIG. 5D is a top view of another example of the web W according to Example 2. In a direction perpendicular to the conveying direction, the electrode substrate W10 has a plurality of active material layers W20a and W20b stacked at intermittent intervals, and both end parts and the central parts of the electrode substrate W10 have no stack of active material layer W20.

FIG. 5E is a top view of a further example of the web W according to Example 2, and in the conveying direction, the electrode substrate W10 has a plurality of active material layers W20c, W20d, and W20e stacked at intermittent intervals.

FIG. 5F is a cross-sectional view of the web W depicted in FIG. 5E, and the back side of the electrode substrate W10 also has a plurality of active material layers W21c, W21d, and W21e stacked at intermittent intervals.

As described so far, when the web W is formed of a stack of the electrode substrate W10 and the active material layer W20, a wrinkle has sometimes generated due to difference in extension or density between the electrode substrate W10 and the active material layer W20, difference in thickness between a part having a stack of the active material layer W20 and a part having no stack of the active material layer W20, or the like. Moreover, also when tension is applied onto the web W, a wrinkle has again sometimes generated due to the aforementioned difference.

In view of the problems described so far, the embodiment further has an object to reduce a shift of a position of a liquid composition applied onto a thin film, due to a wrinkle of a stack being conveyed.

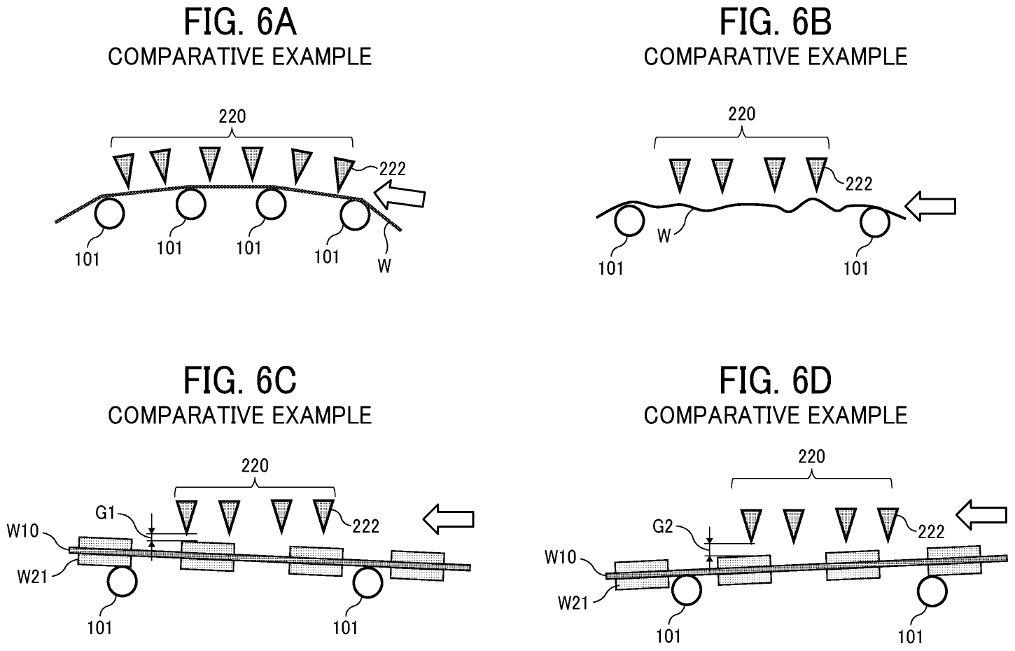

FIG. 6 depicts explanatory diagrams of the comparative examples.

FIG. 6A depicts the inkjet part 220 where a plurality of inkjet heads 222 is arranged along a conveying direction of the web W.

In this case, the web W is supported by a plurality of the guide rollers 101, and the inkjet heads 222 are arranged on a passing path between the guide rollers 101 adjacent to each other.

FIG. 6B depicts the passing path between the guide rollers 101 adjacent to each other illustrated in FIG. 6A.

In this case, in both Example 1 and Example 2 illustrated in FIGS. 4A to 4B and FIGS. 5A to 5F, a wrinkle is generated in the web W, and a conveying directional shift of a position of ink applied onto the web W is exhibited.

Here, it is contemplated that the wrinkle may be extended by applying tension to the web W, but it is difficult to uniformly apply tension to the web W of a thin film, thus rather generating a wrinkle due to variation in tension.

FIG. 6C and FIG. 6D depict passing paths between the guide rollers 101 in conveyance of the web W according to Example 2.

In FIG. 6C and FIG. 6D, whenever a stack of the active material layer W21 intermittently located on the back side of the electrode substrate W10 climbed over the guide roller 101, a gap G between the inkjet head 222 and the web W changed (G1->G2), causing the position of ink applied onto the web W to shift in the conveying direction in the same manner as in generation of a wrinkle in the web W.

Additionally, pressing of the web W including the electrode substrate W10 and the active material layer W20 for increasing the density of the active material layer W20 also results in generation of a wrinkle due to biased extension, a biased thickness, and a biased density associated with the pressing, or in change of the gap G as depicted in FIG. 6C and FIG. 6D due to variation in the thickness of the web W.

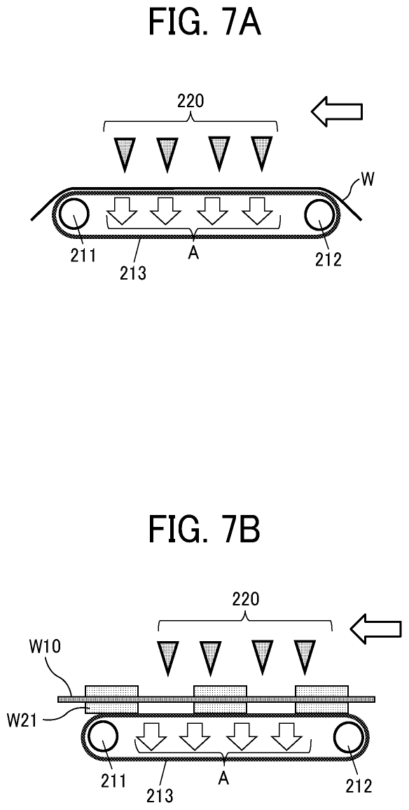

FIGS. 7A and 7B are explanatory diagrams of conveyance of the web W according to the present embodiment.

As depicted in FIG. 7A, the belt 213 conveys the web W with suction in a direction opposite to the inkjet part 220, thus allowing reduction in a conveying directional shift of a position of ink applied onto the web W by the inkjet part 220 due to a wrinkle of the web W being conveyed.

Moreover, the belt 213 sucks the web W by sucking air A by negative pressure, thus also allowing reduction in a wrinkle of the web W caused by an air layer between the web W and the belt 213.

FIG. 7B is an explanatory diagram of conveyance of the web W according to Example 2.

Again in this case, the belt 213 conveys the active material layer W21 intermittently stacked on the back side of the electrode substrate W10 facing the inkjet part 220, with suction in a direction opposite to the inkjet part 220, thus reducing change of the gap G as depicted in FIG. 6C and FIG. 6D, and thereby allowing reduction in a conveying directional shift of a position of ink applied onto the web W by the inkjet part 220.

Furthermore, even when the web W including the electrode substrate W10 and the active material layer W20 is pressed to generate biased extension, a biased thickness, and a biased density, it is possible to reduce generation of a wrinkle, and to reduce change of the gap G in the same manner as in FIG. 7B.

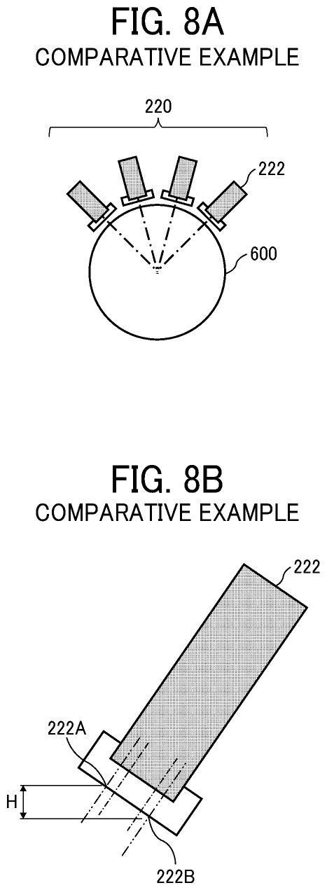

FIGS. 8A and 8B are explanatory diagrams of a second comparative example.

The second comparative example depicted in FIG. 8A winds and conveys the web W on a winding roller 600, and discharges ink from a plurality of the inkjet heads 222 onto the surface of the web W being conveyed by the winding roller 600.

The second comparative example can also reduce a wrinkle of the web W, but has less productivity due to difficulty in increase in the number of the inkjet heads.

FIG. 8B is an explanatory diagram of the inkjet head 222. Inclination of the inkjet head 222 produces difference in height H between a plurality of discharging faces 222A and 222B, and difference in discharge head due to the difference in height H causes ink leakage in the discharging face 222B at a setting of ink pressure suited for the discharging face 222A, and lack of ink discharge in the discharging face 222A at a setting of ink pressure suited for the discharging face 222B.

In other words, limitation of inclination of the inkjet head 222 also limits the number of the inkjet head 222, thus making it difficult to improve productivity.

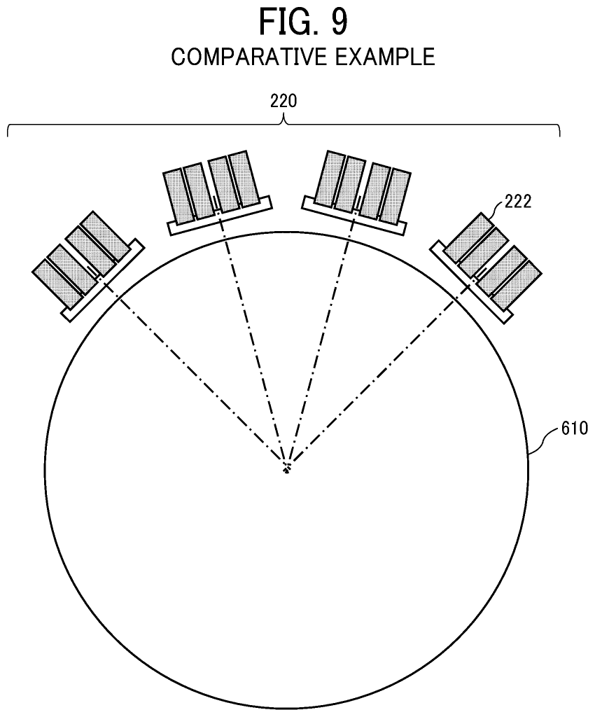

FIG. 9 is another explanatory diagram of the second comparative example.

FIG. 9 depicts an example with use of a winding roller 610 having larger diameter compared to the winding roller 600 illustrated in FIG. 8.

In this case, even with increase in the number of the inkjet heads 222, productivity is improved compared to FIG. 8 because the inclination of each inkjet head 222 is gentler than that in FIG. 8. However, it is difficult to ensure a space for a production facility because most of a space occupied by the winding roller 610 was a dead space.

Thus, the electrode production apparatus 1 according to the present embodiment saves more space and has higher productivity and higher accuracy of a position of ink compared to the second comparative example.

The electrode production apparatus 1 according to the present embodiment may be, as appropriate, configured as an electrochemical element production apparatus by including in a later step, an electrochemical element formation part to form an electrochemical element obtained by an electrode production apparatus.

As described so far, the electrode production apparatus 1 according to an embodiment of the present invention includes the inkjet part 220 configured to apply ink onto the web W being conveyed to form a function layer, and a suction conveying part 210 configured to convey the web W while sucking the web W in a direction opposite to the inkjet part 220. The inkjet part 220 preferably applies ink to a portion of the web W which is located on the suction conveying part 210.

In this context, the electrode production apparatus 1 is an example of a liquid application apparatus, and the web W is an example of a thin film. Ink is an example of a liquid composition, and the inkjet part 220 is an example of an application part. Another example of the liquid application apparatus may be a stack separator production apparatus that employs a separator as the thin film and produces a stack separator in which a function layer is formed on the separator by the application part.

The present embodiment allows reduction in a conveying directional shift of a position of ink applied onto the web W by the inkjet part 220 due to a wrinkle of the web W being conveyed, thus improving accuracy of a position of ink applied onto the web W. Particularly, the present embodiment can provide an electrode with good charging and discharging characteristics or quality.

In particular, when the web W includes the electrode substrate W10, onto which the inkjet part 220 applies ink to form the active material layer 20, the active material layer 20 can be formed with high accuracy on the electrode substrate W10. In this case, the active material layer 20 is an example of an electrode composite layer.

The belt 213 included in the suction conveying part 210 can suck the web W by negative pressure, and thereby also reduce a wrinkle of the web W due to an air layer between the web W and the belt 213, thus improving accuracy of a position of ink applied onto the web W.

The web W includes the electrode substrate W10 and the active material layer W20 stacked on the electrode substrate W10. The electrode substrate W10 is an example of a substrate, and the electrode substrate W10 and the active material layer W20 are example of stacks.

In the present embodiment, even when the electrode substrate W10 and the active material layer W20 have differences in extension, a thickness, and a density, the web W can be provided with reduction in a wrinkle due to these differences, thus improving accuracy of a position of ink applied onto the web W.

In particular, when ink is applied onto an electrode including the electrode substrate W10 and the active material layer W20 to form the insulating layer 30, the insulating layer 30 can be formed with high accuracy on the electrode.

The web W includes a part having a stack of the active material layer W20 on the electrode substrate W10, and a part having no stack of the active material layer W20 on the electrode substrate W10.

The present embodiment can reduce a wrinkle of the web W due to differences in extension, a thickness, and a density between a part having a stack of the active material layer W20 on the electrode substrate W10, and a part having no stack of the active material layer W20 on the electrode substrate W10, thus improving accuracy of a position of ink applied onto the web W.

Furthermore, even when a face opposite to a face facing the inkjet part 220 includes a part having a stack of the active material layer W20 on the electrode substrate W10 and a part having no stack of the active material layer W20 on electrode substrate W10, it is possible to reduce change of a gap between the inkjet part 220 and the web W due to difference in level between the stacked part and the unstacked part. This allows reduction in a conveying directional shift of a position of ink applied onto the web W, in association with change of the gap.

Even when the web W is pressed or otherwise processed to have at least one characteristic of biased extension, a biased thickness, or a biased density, the electrode production apparatus 1 can reduce a wrinkle of the web W caused by such a characteristic, thus improving accuracy of a position of ink applied onto the web W.

Moreover, it is possible to reduce change of a gap of the inkjet part 220 and the web W caused by a biased thickness, thus allowing reduction in a conveying directional shift of a position of ink applied onto the web W, in association with change of the gap.

The electrode production apparatus 1 includes a plurality of the guide rollers 101A to 101E, which are examples of other conveying parts to convey the web W at an upstream part and a downstream part relative to the belt 213, in a conveying direction for conveyance of the web W, and the plurality of the guide rollers 101A to 101E and the suction conveying part 210 apply tension and convey the web W.

In this case, although local tension in the web W is sometimes distributed ununiformly, the suction conveying part 210, which conveys the web W with suction, reduces irregular change of a position of a wrinkle of the web W during conveyance.

In a case where the web W is conveyed by application of stress without provision of the suction conveying part 210, low tension generates a wrinkle due to deflection of the web W. and too strong tension results in ununiform distribution of local tension in the web W and generation of a wrinkle; in both cases, a wrinkle is generated.

By contrast, the present embodiment includes the suction conveying part 210, which conveys the web W with suction, and a wrinkle of the web W is thus reduced at least in a part having ink applied by the inkjet part 220.

In other words, even when a wrinkle is generated in the web W at an upstream part of the suction conveying part 210 in a direction of conveyance of the web W, the wrinkle of the web W is reduced at least in a part in which the web W is conveyed by the suction conveying part 210; the suction conveying part 210 thus has a compensation function to reduce a wrinkle on a conveying pathway for the web W. This is particularly remarkable when the web W is formed of a thin film that is more likely to generate a wrinkle, such as a film or foil.

Meanwhile, the guide rollers 101B and 101C convey the web W so as to incline a face portion of the web W at an upstream part or a downstream part relative to the suction conveying part 210, in a direction in which a face portion of the web W facing the inkjet part 220 is pressed against the belt 213.

This reduces significant floating of the web W relative to the belt 213, thus improving efficiency to reduce a wrinkle of the web W by suction of the belt 213.

The guide rollers 101 preferably, convey the web W substantially horizontally at the downstream part. The electrode production apparatus 1 also preferably includes the encoder 550, which is an example of a detection part to detect a conveyance speed for conveyance of the web W by the belt 213, and the controller 500, which controls a timing for applying ink to the web W by the inkjet part 220 based on detection results by the encoder 550.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

This patent application is based on and claims priority to Japanese Patent Application No. 2022-024421, filed on Feb. 21, 2022, in the Japan Patent Office, the entire disclosure of which is hereby incorporated by reference herein.

### REFERENCE SIGNS LIST

1 electrode production apparatus (an example of liquid application apparatuses)
100 reel-out part
110 reel-out roll
101A to 101E guide rollers (examples of other conveying parts)
W web (an example of thin films)
200 printing part
210 suction conveying part
211 belt driving roller
212 belt following roller
213 belt
214 suction chamber
215 duct
216 blower
220 inkjet part (an example of application parts)
221 inkjet Md
222 inkjet head
222A, 222B discharging face
300 drying part
310: drying oven
400: reel-in part
410: reel-in roll
500 controller
510 head driver
520 roller driver
530 blower driver
550 encoder
560 operation part
600, 610 winding roller
W10 electrode substrate
W20 active material layer (an example of electrode composite layers)
W21 active material layer formed on a back side
20 active material layer (an example of electrode composite layers)
30 insulating layer

1. An electrode production apparatus, comprising:
an applicator to apply a liquid composition to an electrode element being conveyed in a conveying direction, to form a function layer, and
a suction conveyor to convey the electrode element while sucking the electrode element in a direction opposite to the applicator,
wherein the electrode element is a thin film.

2. The electrode production apparatus according to claim 1, further comprising:
other conveyors to convey the electrode element or an electrode having the function layer formed on the electrode element, at an upstream part and a downstream part relative to the suction conveyor in the conveying direction, wherein the other conveyors and the suction conveyor apply tension to convey the electrode element or the electrode.

3. The electrode production apparatus according to claim 2, wherein:
the other conveyors convey the electrode element or the electrode so as to incline a face portion of the electrode element or the electrode at the upstream part or the downstream part relative to the suction conveyor, in a direction in which the face portion of the electrode element or the electrode facing the applicator is pressed against the suction conveyor.

4. The electrode production apparatus according to claim 2, wherein:
the other conveyors convey the electrode element or the electrode substantially horizontally at the downstream part.

5. The electrode production apparatus according to claim 1, wherein:
the applicator applies the liquid composition to a portion of the thin film which is located on the suction conveyor.

6. The electrode production apparatus according to claim 1, further comprising:
a detector to detect a conveyance speed for conveying the electrode element by the suction conveyor; and
control circuitry configured to control a timing for applying the liquid composition to the electrode element by the applicator based on a detection result by the detector.

7. A stack separator production apparatus, comprising:
an applicator to apply a liquid composition to an electrode element being conveyed, to form a function layer; and
a suction conveyor to convey the electrode element while sucking the electrode element in a direction opposite to the applicator,
wherein the electrode element is a separator that is a thin film.

8. A liquid application apparatus, comprising:
an applicator to apply a liquid composition to a thin film being conveyed; and
a suction conveyor to convey the thin film while sucking the thin film in a direction opposite to the applicator.

9. An electrode production method, comprising:
applying a liquid composition by an applicator to an electrode element being conveyed, to form a function layer; and
conveying the electrode element while sucking the electrode element in a direction opposite to the applicator,
wherein the electrode element is a thin film.

10. The electrode production method according to claim 9, wherein:
the electrode element includes an electrode substrate and an electrode composite layer disposed on the electrode substrate, and the function layer is an insulating layer.

11. The electrode production method according to claim 10, wherein:
the electrode element includes a part having a stack of the electrode composite layer on the electrode substrate, and a part having no stack of the electrode composite layer on the electrode substrate.

12. The electrode production method according to claim 9, wherein:
the electrode element includes, in a face opposite to a face facing the applicator, a part having a stack of the electrode composite layer on the electrode substrate and a part having no stack of the electrode composite layer on the electrode substrate.

13. The electrode production method according to claim 9, wherein:
the electrode element has at least one characteristic of biased extension, a biased thickness, and a biased density.

14. A stack separator production method, comprising:
applying a liquid composition by an applicator to an electrode element being conveyed, to form a function layer; and
conveying the electrode element while sucking the electrode element in a direction opposite to the applicator,
wherein the electrode element is a separator that is a thin film.

15. A liquid application method, comprising:
applying a liquid composition by an applicator to a thin film being conveyed; and
conveying the thin film while sucking the thin film in a direction opposite to the applicator.
